(19) United States
(12) Patent Application Publication
(10) Pub. No.: US 2006/0170423 A1
(43) Pub. Date: Aug. 3, 2006

(54) Buried meter and structure measurement system

(76) Inventors: Yuji Kohgo, Ibaraki (JP); Isamu Nakajima, Ibaraki (JP); Shinichi Endoh, Saitama (JP); Ryoichi Tohmetsuka, Tokyo (JP); Nobuyoshi Yamazaki, Tokyo (JP); Komci Yano, Tokyo (JP); Akira Takahashi, Tokyo (JP); Toshiaki Kakue, Tokyo (JP)

Correspondence Address: ARENT FOX PLLC, 1050 CONNECTICUT AVENUE, N.W., SUITE 400, WASHINGTON, DC, 20036, US

(21) Appl. No.: 10/543,661

(22) PCT Filed: Dec. 25, 2003
(86) PCT No.: PCT/JP03/16676

§ 371 Date: Jul. 28, 2005

(30) Foreign Application Priority Data
Jan. 30, 2003 (JP) 2003-22200

(51) Int. Cl. G01V 3/00

(52) U.S. Cl. 324/323

(57) ABSTRACT

A buried type measuring instrument has a sensing unit 10A which is formed in part of a case 10 and senses a physical value pertaining to a change of state of a structure. This case 10 accommodates a transducer 11 for converting the physical value sensed by the sensing unit 10A; a transmission circuit unit 12 for outputting a carrier signal modulated by an output of the transducer 11; a drive unit 13 for driving the transducer 11 and the transmission circuit unit 12 with power supply from a battery 15; and a transmission coil 14 for receiving an output of the transmission circuit unit 12 and generating a low frequency magnetic field signal. This case 10 is buried in the structure. Consequently, it is possible to provide a measuring instrument which can adopt a radio communication mode to secure a sufficient cutoff function of the structure and avoid damage to the measuring sensor, allows remote data acquisition, and even has no adverse effect on strength characteristics of the structure.

### TECHNICAL FIELD

The present invention relates to a buried type measuring instrument which is buried in a structure such as a dam and measures the structure for a change of state, and a structure measurement system using this instrument.

### BACKGROUND ART

For soil structures such as a fill dam, safety management using buried measuring instruments is conducted in order to check the safety of the structures under construction and the safety across the ages. In the case of a fill dam, the dam body becomes structurally unstable when the pore water pressure inside the dam body increases or the earth pressure decreases. Instruments are thus buried in the dam body, and the pore water pressure or earth pressure inside the body is measured to make safety evaluation on the dam.

Among the conventional techniques for measuring the inside of a structure like this are the followings. One is such a method as described in Japanese Patent Application Laid-Open No. Hei 8-81959. In the method, strain gauges covered with a waterproof adhesive are bonded to components of the structure, and the strain gauges are buried in various locations in the structure along with the components of the structure. Transmission cables are led out from these strain gauges and connected to a measuring instrument.

Another is such a method as described in Japanese Patent Application Laid-Open No. 2002-39810. In the method, measuring sensor integral type instruments having a transmitter are buried in the structure. The outputs of the measuring sensors are transmitted from the transmitters outside the structure by electromagnetic waves, and the data is acquired by moving data acquisition means having a receiver to approach the individual measuring sensors in the structure. This method has noncontact, radio communication functions.

According to these conventional examples, however, the former method requires cables for the sake of transmitting the measurement data from the measuring sensors outside the structure, and thus has a problem of higher cost ascribable to the extension of the cables from the measuring sensors buried in a number of locations. In addition, when the method is applied to soil structures having a cutoff function in particular, there occur the following serious problems.

That is, since the cables led out from the measuring sensors exist inside the structure, it is highly possible that continuous pores arise across the structure. These pores can form water channels, possibly impairing the soundness of the structure such as a dam. Moreover, induced lightning may penetrate through the led cables to damage the measuring sensors, thereby causing the problem that not only the measuring sensors but the connected instrument can also be damaged.

The latter method, on the other hand, is free from the foregoing problems since it is of noncontact or radio communications. Nevertheless, since the communication means using electromagnetic waves is adopted, the signals transmitted from inside the structure can be attenuated easily by the components of the structure, the ground, reservoir water, or the like. This requires that the data acquisition means be moved to approach the measuring sensors buried in various locations in the structure, causing the problem of complicated measurement operation.

Moreover, this method is intended to supply electric power and transmit data by using high frequency electromagnetic waves in the first place, and is thus predicated on that the measuring sensor and the receiving instrument are at a rather close distance (on the order of several tens of centimeters). If this is applied to a structure that has a large cross section and is covered at one side with water, such as a dam, most of the signals from the measuring sensors may be attenuated depending on the buried locations. This makes signal detection impossible, causing the problem that practical measurement cannot be made.

Furthermore, with the communication means using electromagnetic waves, it is difficult to enclose the transmitters fully into the cases if consideration is given to practical signal propagation performance. That is, even if a measuring sensor integral type instrument is formed as in the conventional example described above, it is practically impossible to surround the instrument configuration fully by the case. As a result, the transmission coil and the like are laid outside the case so that the wiring is exposed among the components for forming the structure. This can cause partial loss of area or the like, possibly lowering the strength characteristics of the structure.

The present invention has been proposed to address the foregoing circumstances. It is thus an object of the present invention to provide a buried type instrument which can adopt a radio communication mode to secure a sufficient cutoff function of the structure and avoid damage to the measuring sensor, allows remote data acquisition, and even has no adverse effect on the strength characteristics of the structure, and a structure measurement system using this buried type instrument.

### DISCLOSURE OF THE INVENTION

The invention according to claim 1 concerns a buried type measuring instrument, comprising at least: a case to be buried in a structure; a sensing unit for sensing a physical value pertaining to a change of state of the structure, the sensing unit being formed in part of the case; and a transducer for converting the physical value from the sensing unit into an electric signal, a transmission circuit unit for outputting a carrier signal modulated by an output of the transducer, and a transmission coil for receiving an output of the transmission circuit unit and generating a low frequency magnetic field signal, the transducer, the transmission circuit unit, and the transmission coil being accommodated in the case, and wherein the low frequency magnetic field signal is used to trasnit measurement data outside the structure.

The invention according to claim 2 is the buried type instrument according to claim 1, wherein the case is buried in the structure as one of components for forming the structure.

The invention according to claim 3 is the buried type instrument according to claim 1 or 2, comprising a drive unit for activating the transducer and the transmission circuit unit for a certain period of time at set time intervals, and a battery for supplying power to each of the units, the drive unit and the battery being accommodated in the case.

The invention according to claim 4 is the buried type instrument according to claim 1 or 2, comprising a drive control unit for storing data from the transducer at set time intervals and inputting the stored data to the transmission circuit unit at set time intervals, and a battery for supplying power to each of the units, the drive control unit and the battery being accommodated in the case.

The invention according to claim 5 concerns a buried type measuring instrument, comprising: a case to be buried in a structure as one of components for forming the structure; a sensing unit for sensing a physical value pertaining to a change of state of the structure, the sensing unit being formed in part of the case; a transducer for converting the physical value from the sensing unit into an electric signal, a transmission circuit unit for outputting a carrier signal modulated by an output of the transducer, and a transmission coil for receiving an output of the transmission circuit unit and generating a low frequency magnetic field signal, the transducer, the transmission circuit unit, and the transmission coil being accommodated in the case; and a reception coil for receiving a signal from an outside of the structure, and a reception circuit for receiving a reception signal received by the reception coil and performing a content of the signal, the reception coil and the reception circuit being accommodated in the case, and wherein a control signal from the outside of the structure is received to transmit measurement data according to the content of control of the control signal outside the structure.

The invention according to claim 6 is a structure measurement system using the buried type instrument according to any one of claims 1 to 4, wherein: the buried type instrument is buried in a structure; and a reception apparatus for receiving the measurement data transmitted from the transmission coil is installed outside the structure.

The invention according to claim 7 is a structure measurement system using the buried type instrument according to claim 5, wherein: the buried type instrument is buried in a structure; and a reception and control apparatus for receiving the measurement data transmitted from the transmission coil and transmitting the control signal to the reception coil is installed outside the structure.

The present invention characterized as described above provides the following operations.

Firstly, in the buried type instrument according to the present invention, the sensing unit for sensing the change of state of a structure is formed in part of the case, and all the component units are accommodated in the case. This case is buried in the structure. Consequently, the component units of the instrument are protected in the case airtightly even when buried in the structure.

Moreover, cables need not be laid inside the structure because of the radio communication mode in which the transducer converts the physical value sensed by the sensing unit into the electric signal, the transmission circuit unit outputs the carrier signal modulated by the transducer output, and the transmission coil transmits the low frequency magnetic field signal in response to the output of the transmission circuit unit. Consequently, this buried type instrument precludes the formation of water channels ascribable to cable installation and the penetration of induced lightning through cables. This avoids a drop in the cutoff function of the structure, and reduces the possibility of damage significantly when coupled with the fact of being fully surrounded by the case.

Then, the buried type instrument of the present invention uses the low frequency magnetic field signal as the signal to be issued from the transmission coil outside the structure. Thus, even if the transmission coil is fully surrounded by the case and the instrument is covered with peripheral components, the ground, reservoir water, or the like, it is possible to transmit the measurement data to the reception apparatus installed remotely without attenuating the transmission signal. This eliminates the need to move the reception apparatus to approach the buried instrument, thereby allowing more efficient operation for measuring the structure.

Secondly, aside from the foregoing characteristic, the case is buried in the structure as part of the components for forming the structure. Consequently, when the buried type instrument of the present invention is buried in the structure, it is fully surrounded by the case and forms part of the components of the structure. Beside, the strength of the case can be secured to preclude partial loss of area or the like inside the structure, thus causing no adverse effect on the strength characteristics of the structure.

Thirdly, aside from the foregoing characteristics, the drive unit for activating the transducer and the transmission circuit unit for a certain period of time at set time intervals and the battery for supplying power to each of the units are arranged inside the case. The measurement data can thus be transmitted at set time intervals automatically while the intermittent activation suppresses the battery consumption. This allows automation and life extension of the buried type instrument.

Fourthly, aside from the foregoing characteristics, there are provided the drive control unit for storing the data from the transducer at set time intervals and inputting the stored data to the transmission circuit unit at set time intervals. Like the second characteristic described above, the measurement data can thus be stored and transmitted at set time intervals automatically while the intermittent drive control suppresses the battery consumption. This allows automation and life extension of the buried type instrument.

Fifthly, aside from the foregoing characteristics, there are provided the reception coil for receiving the signal from the outside of the structure and the reception circuit unit for receiving the reception signal received by the reception coil and performing the content of the signal. Here, the control signal from the outside of the structure is received to transmit the measurement data according to the content of control of the control signal outside the structure. This makes it possible to transmit the measurement data outside the structure according to the content of control at the stage of receiving the control signal transmitted by radio communications from the outside of the structure. It is therefore possible to exercise control on acquisition of measurement data or the like from the outside of the structure. Besides, the instrument can be activated only when necessary, so that the battery consumption is minimized to allow life extension of the buried type instrument.

Sixthly, with the buried type instruments according to claims 1 to 4, the reception apparatus for receiving the measurement data transmitted from the transmission coil is installed outside the structure to constitute the structure measurement system. Thus, measurement data transmitted from a plurality of buried type instruments buried in various locations in the structure can be received and processed by the reception apparatus which is installed remotely. This allows more efficient operation for measuring the structure.

Seventhly, with the buried type instrument according to claim 5, the reception and control apparatus for receiving the measurement data transmitted from the transmission coil and transmitting the control signal to the reception coil is installed outside the structure to constitute the structure measurement system. Thus, a plurality of buried type instruments buried in various locations in the structure can be controlled by the control signal from the reception and control apparatus which is installed remotely, and the measurement data transmitted from the individual buried type instruments can be received and processed by this reception and control apparatus. This allows more efficient operation for measuring the structure.

### BRIEF DESCRIPTION OF THE DRAWINGS

FIG. 1 is an explanatory diagram showing an embodiment of the buried type instrument according to the present invention.

FIG. 2 is an explanatory diagram showing the buried type instrument and the system configuration of a structure measurement system according to the embodiment of the present invention.

FIG. 3 is an explanatory diagram showing the buried type instrument and the system configuration of the structure measurement system according to another embodiment of the present invention.

FIG. 4 is an explanatory diagram showing the layout of the structure measurement systems according to the embodiments of the present invention.

FIG. 5 is an explanatory diagram showing a communication mode of the structure measurement system according to one embodiment of the present invention.

FIG. 6 is an explanatory diagram showing another communication mode of the structure measurement system according to another embodiment of the present invention.

### BEST MODE FOR CARRYING OUT THE INVENTION

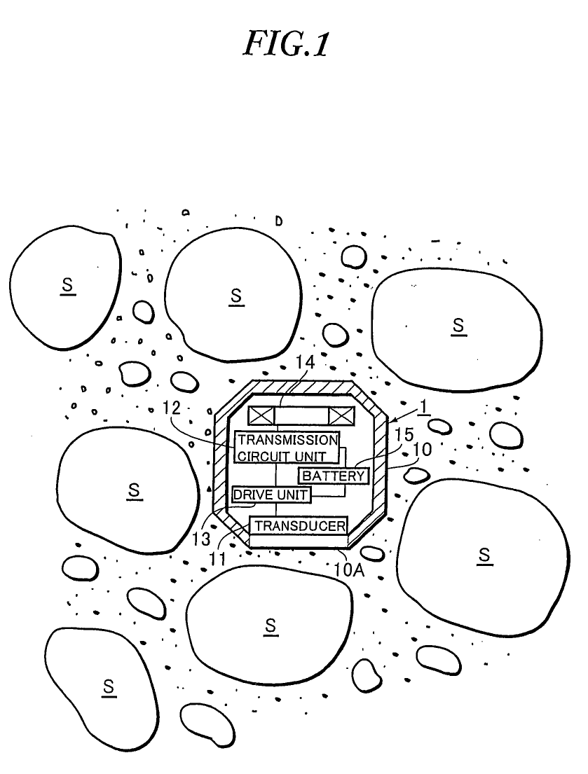

Hereinafter, embodiments of the present invention will be described with reference to the drawings. Initially, referring to FIG. 1, description will be given of a buried type measuring instrument which is an embodiment of the present invention. FIG. 1 shows the state that a buried type measuring instrument 1 according to the embodiment is buried in a structure. This buried type instrument 1 is configured so that it is entirely accommodated in a case 10 having an arbitrary external shape. The case 10 is shaped like a polyhedron, a sphere, or the like, is capable of securing air tightness inside, and is made of a material having a predetermined strength.

Then, a sensing unit 10A for sensing a physical value pertaining to a change of state of the structure is formed in part of this case 10. Here, the physical value may refer to any one related to the management of the state of the structure, such as the amount of strain and the amount of water to be used for measuring a pore water pressure or an earth pressure. The case 10 also accommodates: a transducer 11 for converting the physical value from the sensing unit 10A into an electric signal; a transmission circuit unit 12 for outputting a carrier signal modulated by the output of this transducer 11; a drive unit 13 for activating this transducer 11 and the transmission circuit unit 12 for a certain period of time at set time intervals; a transmission coil 14 for receiving the output of the transmission circuit unit 12 and generating a low frequency magnetic field signal; and a battery 15 for supplying power to these units.

This buried type instrument 1 is configured so that it is entirely and fully surrounded by the case 10. Thus, when the case 10 is formed with the external shape of a polyhedron, a sphere, a cylinder, or a modified form thereof as described above, it can be buried into the structure, for example, as one of aggregates S or components of the structure. Consequently, the buried type instrument becomes part of the components inside the structure. This prevents the instrument, even in the buried state, from causing partial loss of area or the like inside the structure. The buried type instrument 1 can thus be buried without any adverse effect on the strength characteristics of the structure.

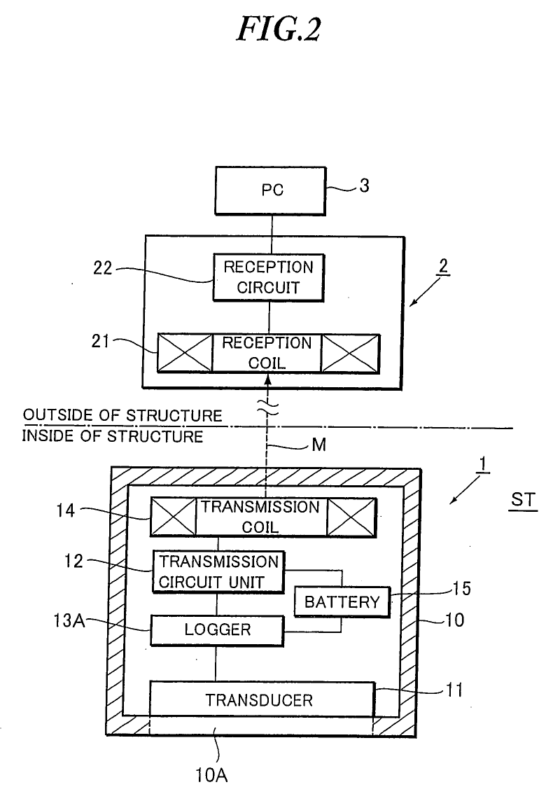

Next, with reference to FIG. 2, description will be given of the operation of the foregoing buried type instrument 1. FIG. 2 shows the foregoing buried type instrument 1 and the system configuration of a structure measurement system using the same. In the diagram, the buried type instrument 1 is buried in a structure ST such as a dam. The buried type instrument 1 has the same system configuration as described previously (identical reference numerals are given to the same parts as in FIG. 1). Here, a logger 13A is used as the drive control unit. In the buried type instrument 1, as described above, the sensing unit 10A is formed in part of the case 10 (the sensing unit 10A may be formed as part of the case 10, or the sensing unit 10A may be embedded in part of the case 10). This makes it possible to measure the change of state of the structure ST directly in the buried environment. Here, the logger 13A has a built-in clock, and makes measurements by using the transducer and stores the measurement data at set times. In other words, it carries out a measurement for a certain period of time at set time intervals, and successively stores the obtained measurement data into a memory. This logger 13A also drives and controls the transmission circuit unit 12. More specifically, at the time of data transmission, the measurement data is input from the logger 13A to the transmission circuit unit 12 at set time intervals. The transmission circuit unit 12 modulates a carrier based on the input measurement data, and the modulated carrier signal is input to the transmission coil 14. Then, the transmission coil 14 generates a low frequency magnetic field signal M from this carrier signal.

Now, description will be given of the low frequency magnetic field signal. Since the signal is substantially composed of magnetic field components alone, it is low in directivity and can thus be transmitted without much attenuation across shields. Consequently, even if the transmission coil 14 is accommodated in the case 10, or buried in the structure ST, the measurement data can be transmitted to remote locations outside the structure without attenuation.

Meanwhile, a reception apparatus 2 is installed remotely outside the structure. This reception apparatus 2 comprises a reception coil 21 and a reception circuit 22. The reception coil 21 receives the low frequency magnetic field signal M to induce a voltage, and this induced voltage is input to the reception circuit 22. The reception circuit 22 amplifies and demodulates this induced voltage, and then inputs it to an information processor (PC) 3 for performing signal processing. The information processor (PC) 3 processes the input signal, and displays it on-screen or stores it into recording means as state change information on the structure.

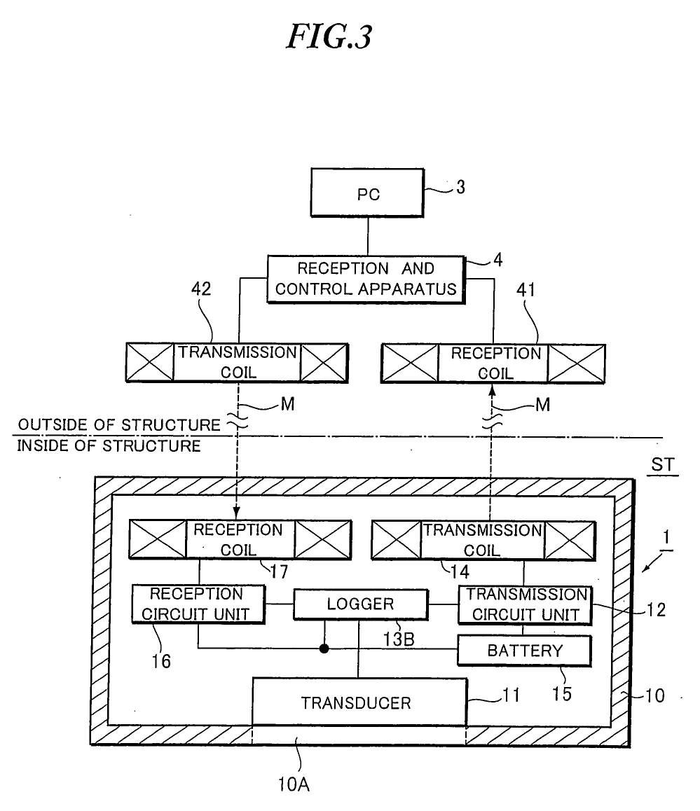

FIG. 3 is a system block diagram showing the structure measurement system according to another embodiment of the present invention. The buried type instrument 1 of this embodiment is the same as that of the foregoing embodiment in that the sensing unit 10A is formed in part of the case 10, and that the transducer 11, the transmission circuit unit 12, the transmission coil 14, and the battery 15 are arranged therein. The buried type instrument 1 of this embodiment uses a logger 13B as the drive control unit. This logger 13B is connected with the transmission circuit unit 12 and a reception circuit unit 16, and this reception circuit unit 16 is connected with a reception coil 17. Moreover, the battery 15 supplies power to the transmission circuit unit 12, the logger 13B, and the reception circuit unit 16.

Then, in the structure measurement system of this embodiment, the buried type instrument 1 described above is buried in a structure ST, and a reception and control apparatus 4 connected with a reception coil 41 and a transmission coil 42 is installed remotely from this structure ST.

According to the structure measurement system of such an embodiment, the sensing unit 10A, the transducer 11, the transmission circuit unit 12, and the transmission coil 14 of the buried type instrument 1 make the same operations as in the foregoing embodiment shown in FIG. 2. A difference from the foregoing embodiment consists, however, in that the operation of the logger 13B can be controlled from the outside of the structure.

More specifically, to transmit measurement data from the buried type instrument 1, the information processor (PC) 3 connected with the reception and control apparatus 4, which is installed remotely from the structure ST, inputs a control signal to the reception and control apparatus 4. This reception and control apparatus 4 modulates the input control signal and outputs it to the transmission coil 42. The transmission coil 42 generates a low frequency magnetic field signal M according to the modulated control signal. This low frequency magnetic field signal M is received by the reception coil 17 in the buried type instrument 1, and the received control signal is analyzed by the reception circuit unit 16. According to this analysis, the logger 13B operates to input the stored measurement data signal to the transmission circuit unit 12. The transmission circuit unit 12 modulates the carrier based on the input measurement data, and the modulated carrier signal is input to the transmission coil 14. Then, the transmission coil 14 generates a low frequency magnetic field signal M from the carrier signal.

The low frequency magnetic field signal M containing this measurement data is received by the reception coil 41 which is installed outside the structure. The reception coil 41 receives the low frequency magnetic field signal to induce a voltage, and the induced voltage is input to the reception and control apparatus 4. The reception and control apparatus 4 amplifies and demodulates the induced voltage, and then outputs it to the information processor (PC) 3. The information processor (PC) 3 processes the input signal, and displays it on-screen or stores it into recording means as the state change information on the structure.

According to such an embodiment, the buried type instrument 1 can be operated to acquire measurement data only when necessary. This makes it possible to suppress the battery consumption to the minimum for the sake of life extension of the buried type instrument 1. In addition, since the buried type instrument 1 can be controlled from the outside of the structure, it is possible to control the sampling intervals and the like as appropriate.

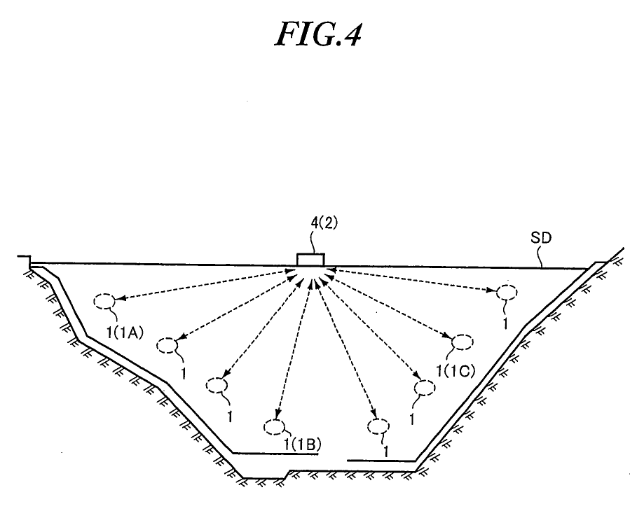

FIG. 4 is an explanatory diagram schematically showing the layout of the structure measurement systems according to the embodiments. The following description will deal with an example of a dam body, a cutoff structure. A number of buried type instruments 1 (1A, 1B, 1C) described above are buried at necessary locations in the dam body SD depending on the item to be measured for. Meanwhile, the reception and control apparatus 4 (or the reception apparatus 2) described above is installed at a predetermined location outside the dam body SD. Here, the reception and control apparatus 4 may be installed at the top of the dam body SD as shown in the diagram, or may be installed inside a dam corridor formed in the bottom of the dam body SD. In essence, the reception and control apparatus lo 4 (or the reception apparatus 2) need not be put close to each individual buried type instrument 1, but the reception and control apparatus 4 (or the reception apparatus 2) corresponding to all the buried type instruments 1 may be installed in a remote location.

According to the embodiments of the present invention, the system can be constructed by installing a single reception and control apparatus 4 or reception apparatus 2 for a plurality of buried type instruments 1. Hereinafter, examples of the communication mode intended here will be described.

FIG. 5 is an explanatory diagram for explaining an example of the communication mode for the structure measurement system according to the embodiment shown in FIG. 2. In this example, the loggers 13A of the buried type instruments 1A, 1B, and 1C buried in different locations are given respective different time settings. More specifically, at a certain time T1, the buried type instrument 1A makes the operation for transmitting measurement data for a certain period of time t. At a subsequent time T2, the buried type instrument 1B makes the operation for transmitting measurement data for a certain period of time t. Moreover, at a subsequent time T3 , the buried type instrument 1C makes the operation for transmitting measurement data for a certain period of time t. Consequently, the measurement data is transmitted to the reception apparatus 2 from the different buried type instruments at different times in succession, and the information processor 3 processes it for data analysis.

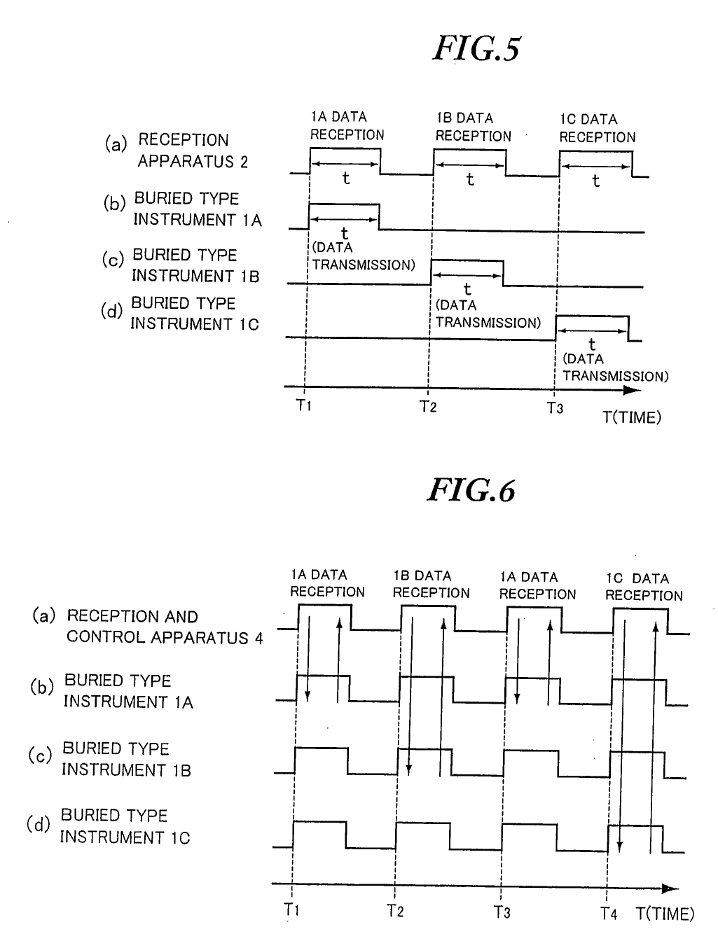

FIG. 6 is an explanatory diagram for explaining an example of the communication mode for the structure measurement system according to the embodiment shown in FIG. 3. In this example, the buried type instruments buried in different locations are given a unique number each, and the reception and control apparatus 4 installed outside the structure transmits control signals corresponding to these numbers. The single reception and control apparatus 4 thereby conducts two-way communications with the plurality of buried type instruments without interference.

More specifically, in the buried type instruments 1A to 1C, the respective loggers 13B store measurement data at arbitrary set times (T1, T2, . . . ). These set times (T1, T2, . . . ) may be common among the instruments, or may be different one by one. Meanwhile, the reception and control apparatus 4 transmits the control signals corresponding to the respective instruments in an arbitrary or predetermined pattern. Under the control of those control signals, one of the buried type instruments transmits the measurement data stored in its logger 13B. The reception and control apparatus 4 receives the measurement data transmitted from each buried type instrument successively, and sends it to the information processor 3 for data processing.

As described above, when the buried type instrument or the structure measurement system according to the embodiment of the present invention is used with a dam body as the target structure, it is possible to bury the buried type instruments at respective measuring points in the dam body and transmit the measurement data on the respective points to the top of the dam body or to the corridor by radio communications. This eliminates the need for cable laying, and makes it possible to shorten the construction period and reduce the cost without hindering the progress of the dam body banking.

Moreover, the absence of cables not only precludes the formation of water channels and a drop in the soundness of the dam body, but also avoids the risk that the buried instruments might be damaged by the penetration of induced lightning through cables or the water immersion through water channels. This allows measurement of high reliability and excellent durability.

Moreover, since the transmission of the measurement data from the buried type instruments and the transmission of the control signals to the buried type instruments use low frequency magnetic field signals, it is possible to transmit and receive the measurement data or control signals at remote locations from the buried type instruments. This can improve the operating efficiency of the structure measurement.

Then, the buried type instrument according to the embodiment of the present invention is entirely surrounded by a case, and this case is buried as one of the components of the structure. This means no adverse effect on the strength characteristics of the structure.

Furthermore, in the embodiment capable of two-way communications, the buried type instrument can be activated only when necessary. It is therefore possible to suppress the consumption of the battery built in the buried type instrument to the minimum, allowing life extension of the buried type instrument.

### INDUSTRIAL APPLICABILITY

Since the present invention has the foregoing configuration, it becomes possible to provide a buried type measuring instrument which can adopt a radio communication mode to secure a sufficient cutoff function of the structure and avoid damage to the measuring sensor, allows remote data acquisition, and even has no adverse effect on the strength characteristics of the structure, and a structure measurement system using this buried type instrument.

1. A buried type measuring instrument, comprising at least:
a case to be buried in a structure;
a sensing unit for sensing a physical value pertaining to a change of state of the structure, the sensing unit being formed in part of the case;
a transducer for converting the physical value from the sensing unit into an electric signal;
a transmission circuit unit for outputting a carrier signal modulated by an output of the transducer; and
a transmission coil for receiving an output of the transmission circuit unit and generating a low frequency magnetic field signal, each of the transducer, the transmission circuit unit, and the transmission coil being accommodated in the case,
wherein the low frequency magnetic field signal is used to transmit measurement data outside the structure.

2. The buried type measuring instrument according to claim 1, wherein the case is buried in the structure as one of components for forming the structure.

3. The buried type measuring instrument according to claim 1, further comprising:
a drive unit for activating the transducer and the transmission circuit unit for a certain period of time at set time intervals; and
a battery for supplying power to each of the units, the drive unit and the battery being accommodated in the case.

4. The buried type measuring instrument according to claim 1, further comprising:
a drive control unit for storing data from the transducer at set time intervals and inputting the stored data to the transmission circuit unit at set time intervals; and
a battery for supplying power to each of the units, the drive control unit and the battery being accommodated in the case.

5. A buried type measuring instrument, comprising:
a case to be buried in a structure as one of components for forming the structure;
a sensing unit for sensing a physical value pertaining to a change of state of the structure, the sensing unit being formed in part of the case;
a transducer for converting the physical value from the sensing unit into an electric signal;
a transmission circuit unit for outputting a carrier signal modulated by an output of the transducer;
a transmission coil for receiving an output of the transmission circuit unit and generating a low frequency magnetic field signal, each of the transducer, the transmission circuit unit, and the transmission coil being accommodated in the case;
a reception coil for receiving a signal from an outside of the structure; and
a reception circuit unit for receiving a reception signal received by the reception coil and performing a content of the signal, the reception coil and the reception circuit unit being accommodated in the case,
wherein a control signal from the outside of the structure is received to transmit measurement data according to the content of control of the control signal outside the structure.

6. A structure measurement system using the buried type measuring instrument according to claim 1, wherein:
the buried type instrument is buried in a structure; and a reception apparatus for receiving the measurement data transmitted from the transmission coil is installed outside the structure.

7. A structure measurement system using the buried type instrument according to claim 5, wherein:
the buried type instrument is buried in a structure; and
a reception and control apparatus for receiving the measurement data transmitted from the transmission coil and transmitting the control signal to the reception coil is installed outside the structure.

8. The buried type measuring instrument according to claim 2, further comprising:
a drive unit for activating the transducer and the transmission circuit unit for a certain period of time at set time intervals; and
a battery for supplying power to each of the units, the drive unit and the battery being accommodated in the case.

9. The buried type measuring instrument according to claim 2, further comprising:
a drive control unit for storing data from the transducer at set time intervals and inputting the stored data to the transmission circuit unit at set time intervals; and
a battery for supplying power to each of the units, the drive control unit and the battery being accommodated in the case.

10. A structure measurement system using the buried type measuring instrument according to claim 2, wherein:
the buried type instrument is buried in a structure; and a reception apparatus for receiving the measurement data transmitted from the transmission coil is installed outside the structure.

11. A structure measurement system using the buried type measuring instrument according to claim 3, wherein:
the buried type instrument is buried in a structure; and a reception apparatus for receiving the measurement data transmitted from the transmission coil is installed outside the structure.

12. A structure measurement system using the buried type measuring instrument according to claim 8, wherein:
the buried type instrument is buried in a structure; and a reception apparatus for receiving the measurement data transmitted from the transmission coil is installed outside the structure.

13. A structure measurement system using the buried type measuring instrument according to claim 4, wherein:
the buried type instrument is buried in a structure; and a reception apparatus for receiving the measurement data transmitted from the transmission coil is installed outside the structure.

14. A structure measurement system using the buried type measuring instrument according to claim 9, wherein:
the buried type instrument is buried in a structure; and a reception apparatus for receiving the measurement data transmitted from the transmission coil is installed outside the structure.
